(19) United States
(12) Patent Application Publication
(10) Pub. No.: US 2002/0134540 A1
(43) Pub. Date: Sep. 26, 2002

(54) Automobile air-conditioner having means for adjusting air-conditioning ability under bilevel mode

(76) Inventors: Hisashi Ieda, Nagoya-city (JP); Mitsuyo Oomura, Hekinan-city (JP)

Correspondence Address: HARNESS, DICKEY & PIERCE, P.L.C., P.O. BOX 828, BLOOMFIELD HILLS, MI, 48303, US

(21) Appl. No.: 10/104,095

(22) Filed: Mar. 22, 2002

(30) Foreign Application Priority Data
Mar. 23, 2001 (JP) 2001-85724

(51) Int. Cl. B60H 3/00; B61D 27/00; B60H 1/00

(52) U.S. Cl. 165/204; 165/42; 165/43; 236/91 C; 236/91 D

(57) ABSTRACT

An automotive air-conditioner operates under three modes: a face mode in which cool air is blown toward a passenger's face, a foot mode in which hot air is blown toward passenger's feet, and a bilevel mode in which the cool air and the hot air are blown to the face and the feet, respectively. Under the bilevel mode, either a cooling ability or a heating ability of the air-conditioner, or both, are increased, compared with those under the face mode and the foot mode. Thus, a temperature difference between air supplied to the face and air supplied to the feet becomes large, thereby providing the passenger with an improved feeling of air-conditioning.

### CROSS-REFERENCE TO RELATED APPLICATION

This application is based upon and claims benefit of priority of Japanese Patent Application No. 2001-85724 filed on Mar. 23, 2001, the content of which is incorporated herein by reference.

### BACKGROUND OF THE INVENTION

1. Field of the Invention

The present invention relates to an air-conditioner for use in an electric automobile driven by an electric motor or a hybrid automobile driven by an internal combustion engine and an electric motor.

2. Description of Related Art

An automobile air-conditioner is generally operated under three modes: a foot mode under which conditioned air is blown downward toward passenger's feet in a passenger compartment; a face mode under which conditioned air is blown upward toward a passenger's face; and a bilevel mode under which conditioned air is blown toward passenger's face and feet. Those three modes are switched from one to another according to air-conditioning situations. Generally, the air-conditioner is operated under the face mode in a hot climate to blow cool air upward toward a passenger's face. It is operated under the foot mode in a cold climate to blow hot air downward toward passenger's feet. It is operated under the bilevel mode in an intermediate climate to blow cool air upward and hot air downward, thus providing passengers with comfort of air-conditioning.

Operation of the air-conditioner under such various modes is disclosed, e.g., in JP-A-8-197937. However, it does not provide a way of further improving passenger's comfort in the intermediate climate.

### SUMMARY OF THE INVENTION

The present invention has been made to improve passenger's feeling and comfort in an intermediate climate, especially when the air-conditioner is operated under the bilevel mode.

The air-conditioner is composed of an air duct in which an evaporator for cooling air introduced into the air duct and a heater for heating the air cooled by the evaporator are disposed, a refrigeration cycle for supplying condensed refrigerant to the evaporator, and a heat source for supplying heat to the heater. Conditioned air is blown out from the air duct through outlet ducts including a face duct and a foot duct. Conditioned cool air is blown out from the face duct upward toward a passenger's face when the air-conditioner is operating under a face mode. Conditioned hot air is blown out from the foot duct downward toward passenger's feet when the air-conditioner is operating under a foot mode. The conditioned cool air is blown out from the face duct and the conditioned hot air is blown out from the foot duct when the air-conditioner is operating under a bilevel mode.

A cooling ability of the evaporator and a heating ability of the heater are determined to obtain a target temperature of the air blown out form the air duct. Both the cooling ability and the heating ability determined under the face mode and the foot mode are increased when the air-conditioner operates under the bilevel mode. By increasing both abilities in cooling and heating under the bilevel mode, cooler air is blown from the face duct and hotter air is blown from the foot duct, compared with those blown under the face mode and the foot mode. In this manner, a temperature difference between the air blown toward the passenger's face and the air blown toward the passenger's feet becomes large when the air-conditioner is operating under the bilevel mode. The temperature difference may be set, for example, to a range from 10 to 15° C. Thus, the air-conditioner can provide the passenger with good feeling of air-conditioning under the bilevel mode. To obtain such a temperature difference, either one of the heating ability or the cooling ability may be increased under the bilevel mode, instead of increasing both.

Preferably, an air-mixing door for mixing the air cooled by the evaporator and the air heated by the heater is controlled to a position to fully shut off the heated air when the air-conditioner is operating under the face mode. On the other hand, the air-mixing door is controlled to a position to fully supply the heated air when the air-conditioner is operating under the foot mode. In this manner, power consumed by the air-conditioner can be reduced.

According to the present invention, the air-conditioner is able to provide a passenger with a good feeling and comfort of air-conditioning when the air-conditioner is operating under the bilevel mode. Other objects and features of the present invention will become more readily apparent from a better understanding of the preferred embodiments described below with reference to the following drawings.

### BRIEF DESCRIPTION OF THE DRAWINGS

FIG. 1 is a schematic diagram showing an air-conditioning system according to the present invention;

FIG. 2 is a perspective view showing an auxiliary heater used in the air-conditioning system shown in FIG. 1, a part of the auxiliary heater being broken to show its inside structure;

FIG. 3 is a partial cross-sectional view showing a coolant passage groove formed in the auxiliary heater shown in FIG. 2;

FIG. 4 is a partial cross-sectional view showing a coolant temperature sensor installed in the auxiliary heater;

FIG. 5 is a diagram showing an electrical circuit for controlling operation of the air-conditioner;

FIG. 6 is a flowchart showing a process of controlling operation of the air-conditioner;

FIG. 7 is a graph showing three operating modes, a foot mode, a bilevel mode and a face mode, which are switched according to respective target temperature TAO;

FIG. 8 is a graph showing three control modes of an air-mixing door, which are switched according to a target temperature TAO;

FIG. 9 is a graph showing a relation between a target temperature after-evaporator TEO and an atmospheric temperature Tam;

FIG. 10A is a graph showing a relation between a target coolant temperature TWO and the target temperature TAO in a modified form;

FIG. 10B is a graph showing a relation between the target temperature after-evaporator TEO and the atmospheric temperature Tam in a modified form; and

FIG. 11 is a graph showing three control modes of an air-mixing door, which are switched according to a control parameter temperature (TAO−Tin) in a second embodiment of the present invention.

### DETAILED DESCRIPTION OF THE PREFERRED EMBODIMENTS

(First Embodiment)

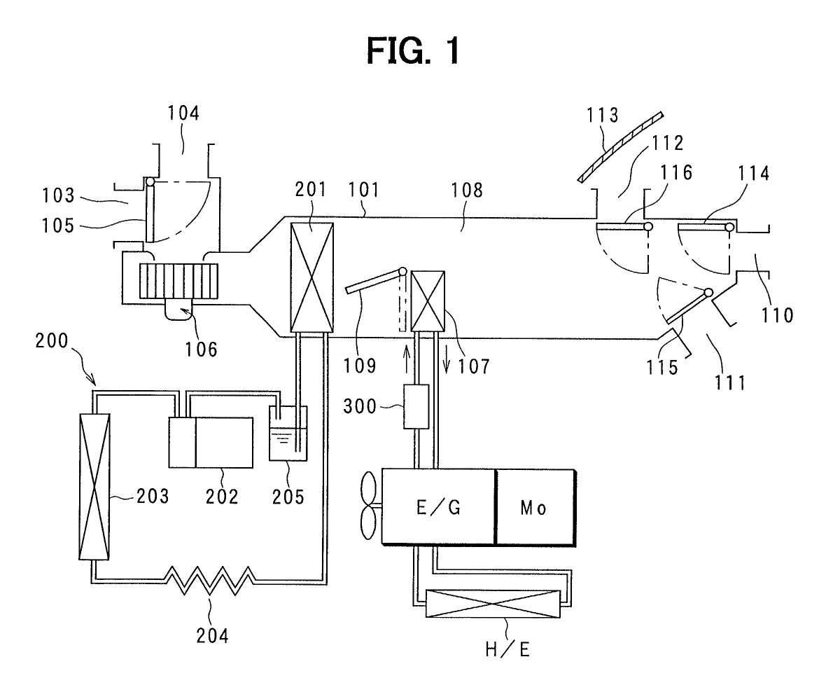

A first embodiment of the present invention will be described with reference to FIGS. 1-9. First, referring to FIG. 1, an entire structure of an air-conditioning system of the present invention will be described. The air-conditioner shown in FIG. 1 is used in a hybrid automobile which is driven by an internal combustion engine E/G and an electric motor Mo. The air-conditioner includes an air duct 101 through which conditioned air is blown out to a passenger compartment, a vapor-compressing refrigeration cycle 200 and a heater 107 to which hot coolant is supplied from the internal combustion engine E/G.

An inside air inlet 103 from which air in a passenger compartment is introduced and an outside air inlet 104 from which atmospheric air is introduced are formed at an upstream end of the air duct 101. The inside air inlet 103 and the outside air inlet 104 are selectively opened or closed by a switching door 105. A centrifugal blower 106 for supplying air into the air duct 101 is disposed downstream of both air inlets 103 and 104.

The refrigeration cycle 200 is composed of, as known hitherto, a compressor 202 that compresses refrigerant therein, a condenser 203 that cools and condenses the refrigerant supplied from the compressor 202, a depressurizer 204 (a fixed orifice formed by a capillary tube in this particular embodiment) that depressurizes the condensed refrigerant supplied from the condenser 203, an evaporator 201 that vaporizes the condensed refrigerant supplied from the condenser 203 through the depressurizer 204, and an accumulator 205 that separates gaseous refrigerant from liquid refrigerant and supplies the gaseous refrigerant to the compressor 202. The evaporator 201 that functions as a heat exchanger of a low pressure side in the refrigeration cycle 200 is disposed downstream of the blower 106 in the air duct 101. An electric motor is integrally included in the compressor 202, and a refrigeration ability, or capacity, of the refrigeration cycle 200 is controlled by controlling a rotational speed of the motor.

The heater 107 to which coolant for cooling the internal combustion engine E/G is supplied is disposed downstream of the evaporator 201. The coolant also flows into a radiator H/E that cools the coolant heated by the internal combustion engine E/G. A bypass passage 108 through which air cooled by the evaporator 201 flows, bypassing the heater 107, is formed in the air duct 101. An amount of air that is cooled by the evaporator 201 and flows through the heater 107 is controlled by controlling an opening degree of an air-mixing door 109. When the air-mixing door 109 is fully closed (its opening degree is zero), all of the cool air supplied from the evaporator 201 flows through the bypass passage 108, while all of the cool air flows through the heater 107 when the air-mixing door 109 is fully opened (its opening degree is 100%).

At a downstream end of the air duct 101, three outlets are connected to the air duct 101: a face outlet 110 from which conditioned air is blown upward toward a face position of a passenger, a foot outlet 111 from which conditioned air is blown downward toward feet of the passenger, and a defroster outlet 112 from which conditioned air is blown toward a windshield. Those outlets 110, 111, 112 are respectively opened or closed by doors 114, 115, 116. An Operating mode under which the conditioned air is blown from the face outlet 110 is referred to as a face mode. An operating mode under which the conditioned air is blown from the foot outlet 111 is referred to as a foot mode. An operating mode under which the conditioned air is blown from both the face outlet 110 and foot outlet 111 is referred to as a bilevel mode. Another mode under which the conditioned air is supplied to the windshield from the defroster outlet 112 is referred to as a defroster mode.

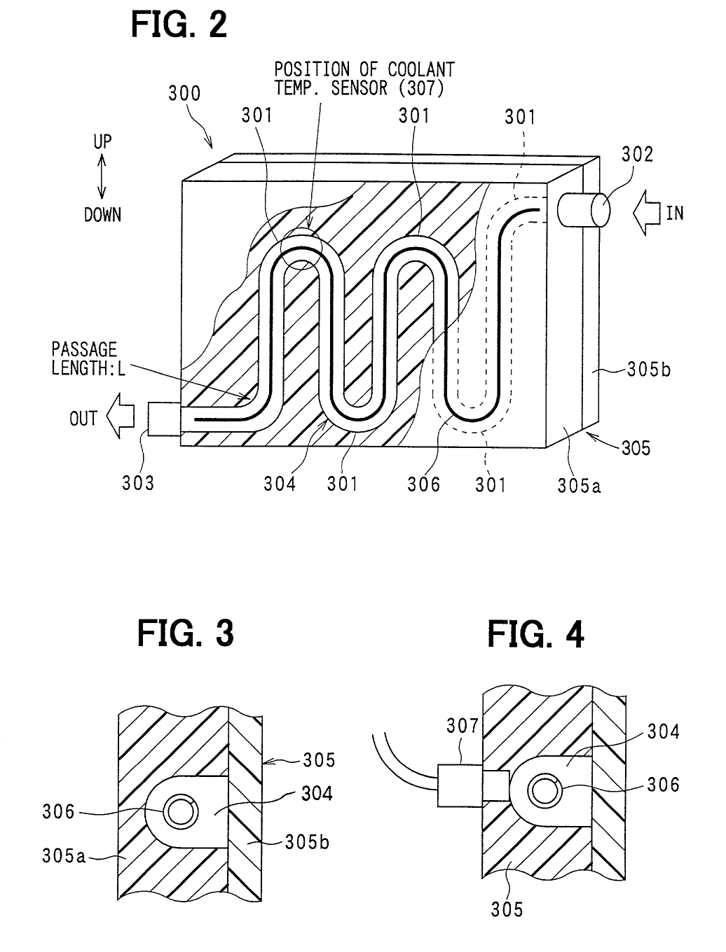

An auxiliary heater 300 is disposed in a coolant passage connecting the heater 107 and the internal combustion engine E/G. The auxiliary heater 300 additionally heats the coolant supplied from the internal combustion engine when the coolant temperature is low. FIG. 2 shows the auxiliary heater 300 which is formed in a heater casing 305 composed of a first heater casing 305a and a second heater casing 305b, both made of a resin material (PPS resin in this particular embodiment). A serpentine coolant passage 304 having plural turning portions is formed in the heater casing 305. The coolant enters the auxiliary heater 300 from a coolant inlet 302, flows through the coolant passage 304 and flows out from a coolant outlet 303. An electric heater wire 306 in a sheath is disposed in the serpentine coolant passage 304. An amount of heat generated by the heater wire 306 is controlled by an electronic control unit 400 (described later) according to the coolant temperature. As shown in FIG. 3, a groove is formed in the first heater casing 305a, and an opening of the groove is water-tightly closed with the second heater casing 305b, thus forming the serpentine coolant passage 304.

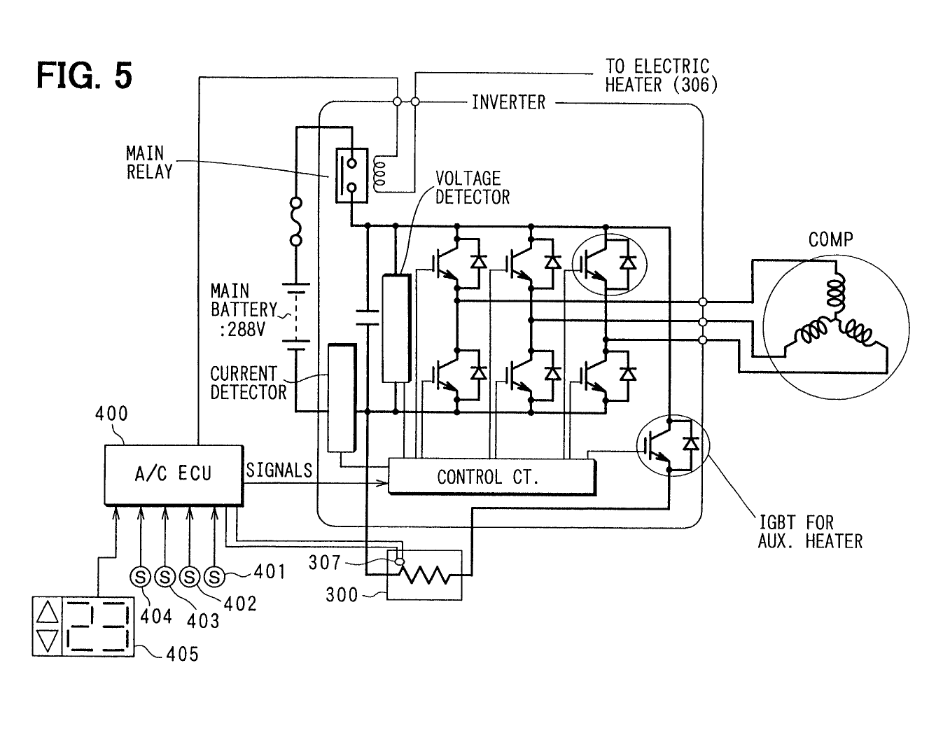

As shown in FIGS. 2 and 4, a coolant temperature sensor 307 is installed in the coolant passage 304 at a top position of one of the turning portions 301. The coolant temperature sensor 307 is installed in the coolant passage 304 at a position which is more than 1/2 L apart from the coolant inlet 302, preferably more than 3/4 L, assuming a total length of the coolant passage is L. As shown in FIG. 4, the coolant temperature sensor 307 is water-tightly installed in the coolant passage 304, so that it is directly disposed to the coolant flowing through the coolant passage 304. The coolant temperature sensor 307 feeds its signals to the electronic control unit 400 shown in FIG. 5.

FIG. 5 shows an electric circuit for driving the motor of the compressor 202, for controlling the auxiliary heater 300 and for performing other controls according to signals from the electronic control unit 400. The compressor motor is driven by an inverter driving circuit in a controlled manner, and an amount of electric current supplied to the heater wire 306 in the auxiliary heater 300 is controlled by an IGBT. A main relay is connected to the inverter circuit to prevent an over-current from being supplied to the inverter circuit.

The electronic control unit 400 generates signals necessary to control the entire operation of the air-conditioner. Signals from various sensors are fed to the electronic control unit 400. Those sensor include: an ambient temperature sensor 401, a sensor 402 for measuring air temperature at an immediate downstream position of the evaporator 201 (referred to as an after-evaporator temperature sensor), a sensor 403 for measuring a temperature in a passenger compartment, and a sunshine sensor 404 for measuring an amount of sunshine heat. Further, a control panel 405 through which a temperature desired by a passenger is inputted is connected to the electronic control unit 400.

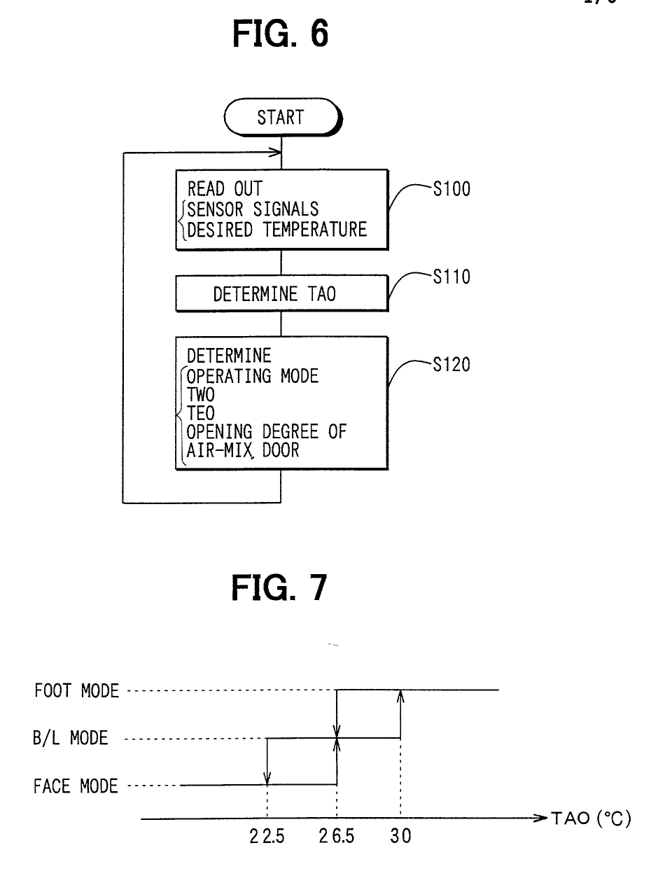

Now, referring to FIG. 6, a process of controlling the air-conditioner will be described. Upon switching-on the air-conditioner, all the sensor signals fed to the electronic control unit 400 including the desired temperature set by a passenger are read out at step S100. Then, at step S110, a target temperature of conditioned air blown out of the air duct 101 (TAO) is calculated according to the following formula: TAO=(Kset×Tset)−(Kr×Tr)−(Kam×Tam)−(Ks×Ts)+C, where: Tset is a desired temperature set by a passenger; Tr is a compartment temperature measured by the sensor 403; Tam is an ambient temperature measured by the ambient temperature sensor 401; Ts is an amount of sunshine detected by the sunshine sensor 404; factors Kset, Kr, Kam and Ks are respective control gains; and C is a constant for adjustment.

Then, at step S120, the followings are determined based on the target temperature TAO calculated at step S110: an operating mode (selected from among the face mode, the foot mode and the bilevel mode); a target coolant temperature TWO (a temperature of the coolant supplied to the heater 107); a target temperature after-evaporator TEO (a temperature of air blown out from the evaporator 201); and an opening degree of the air-mixing door 109. The compressor 202 and the auxiliary heater 300 are controlled to attain the determined targets TWO and TEO. At the same time, the doors 114, 115 and 116 are controlled to bring the operation mode to the determined mode.

The operating modes are switched from one mode to another mode according to the target temperature TAO. As shown in FIG. 7, the air-conditioner is operated under the face mode when TAO is lower than a first predetermined temperature T1, while it is operated under the foot mode when TAO is higher than a second predetermined temperature T2. It is operated under the bilevel mode when TAO is between T1 and T2. However, the operating modes are switched with a certain hysteresis to improve passenger's feeling in air-conditioning. That is, as exemplified in FIG. 7, the operating mode is switched from the face mode to the bilevel mode when TAO reaches 26.5° C., while it is switched from the bilevel mode to the face mode when TAO becomes 22.5° C. Similarly, the operating mode is switched from the bilevel mode to the foot mode when TAO reaches 30° C., while it is switched from the foot mode to the bilevel mode when TAO becomes 26.5° C.

The opening degree SW of the air-mixing door 109 (referred to as an air-mixing door mode) is also controlled according to the target temperature TAO. The opening degree SW is brought to substantially 0% (fully closed) when TAO is lower than the first predetermined temperature T1, and it is brought to substantially 100% (fully opened) when TAO is higher than the second predetermined temperature T2. The opening degree SW is controlled according to the following formula when TAO is between T1 and T2: SW=(TAO−TE)/(TW−TE)×100%, where TE is an air temperature after-evaporator detected by the sensor 402, and TW is a coolant temperature detected by the sensor 307.

An air-mixing door mode under which the opening degree SW of the air-mixing door 109 is fixed to 0% is called Max-Cool control mode. An air-mixing door mode under which the opening degree SW of the air-mixing door 109 is fixed to 100% is called Max-Hot control mode. An air-mixing door mode under which the opening degree SW of the air-mixing door 109 is controlled according to the formula (TAO−TE)/(TW−TE)×100% is called A/M control mode.

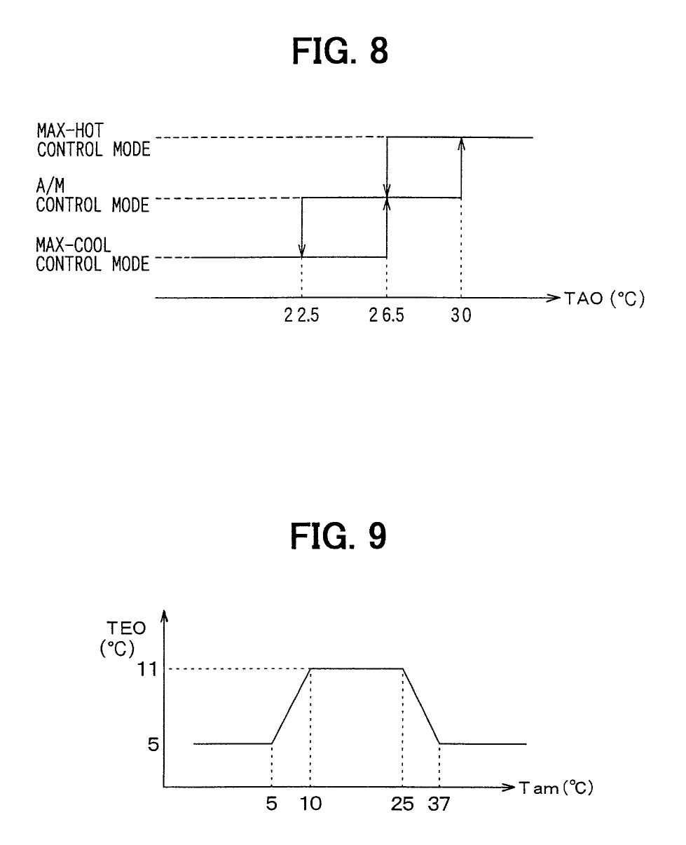

The air-mixing door mode is controlled with a certain hysteresis in the same manner as in the operating mode control. As exemplified in FIG. 8, the Max-Cool control mode is switched to the A/M control mode when TAO reaches 26.5° C., while the A/M control mode is switched to the Max-Cool control mode when TAO becomes 22.5° C. Similarly, the A/M control mode is switched to the Max-Hot control mode when TAO reaches 30° C., while the Max-Hot control mode is switched to the A/M control mode when TAO becomes 26.5° C. In this particular embodiment, the first predetermined temperature T1 and the second predetermined temperature T2 are common to the operating mode and the air-mixing door mode. Accordingly, the air-mixing door 109 is brought to the Max-Cool control mode when the operating mode is under the face mode, to the A/M control mode when the operating mode is under the bilevel mode, and to the Max-Hot control mode when the operating mode is under the foot mode.

The target coolant temperature TWO under both the face mode and the foot mode is determined according to the following formula: TWO=(TAO−TE)/ø+TE, where ø is a temperature efficiency of the heater 107. The target coolant temperature TWO under the bilevel mode is determined according to the following formula: TWO=(TAO−TE)/ø+TE+α, where α is an adjusting factor having a positive value. In other words, the target coolant temperature TWO set under the bilevel mode is higher by α than TWO set under other operating modes, the face mode and the foot mode. Usually, the target coolant temperature TWO calculated according to the above formula under the face mode becomes negative. Therefore, no electric current is supplied to the auxiliary heater 300 under the face mode, thereby making the target temperature after-evaporator TEO equal to the target temperature TAO.

As shown in FIG. 9, the target temperature after-evaporator TEO is determined according to the atmospheric temperature Tam when the air-conditioner operates under the face mode and the foot mode. On the other hand, TEO is determined, under the bilevel mode, according to the following formula: TEO=f(Tam)−β, where f(Tam) is TEO determined by the graph shown in FIG. 9, and β is an adjusting constant having a positive value. In other words, the target temperature after-evaporator TEO is set, under the bilevel mode, to a level lower by β than TEO set under the face mode and the foot mode.

As described above, when the air-conditioner operates under the bilevel mode, the target coolant temperature TWO is set higher than TWO set under other operating modes, and the target temperature after-evaporator TEO is set lower than TEO set under other operating modes. That is, the cooling ability of the evaporator 201 and the heating ability of the auxiliary heater 300 are raised under the bilevel mode compared with those under the face mode and the foot mode. Therefore, a temperature difference between the cool air flowing through the bypass passage 108 and the hot air flowing through the heater 107 becomes large under the bilevel mode. That is, cooler air is blown toward a passenger's face and a hotter air is blown toward passenger's feet when the air-conditioner operates under the bilevel mode. For example, the temperature difference between the cool air and the hot air is set to a range from 10° C. to 15° C. Accordingly, good feeling in air-conditioning can be given to passengers under the bilevel mode. In addition, since the air-conditioner is operated under the bilevel mode mostly in the intermediate climate (not so hot and not so cold), a high air-conditioning power is not required to raise the heating ability and the cooling ability under the bilevel mode.

Advantages attained in the first embodiment described above can be summarized as below. Under the bilevel mode, good feeling and comfort in air-conditioning are given to passengers while suppressing additional power consumption. Under both the face mode and the foot mode, less air-conditioning power is required, compared with that of a conventional air-conditioner in which hot air and cool air mixed by an air-mixing door are supplied to a passenger compartment. This is because, under the face mode, the air-mixing door 109 is fully closed, the auxiliary heater 300 is not energized, and the cooling ability is solely controlled by the compressor 202. Under the foot mode, the air-mixing door is fully opened, and the heating ability is controlled by the auxiliary heater 300.

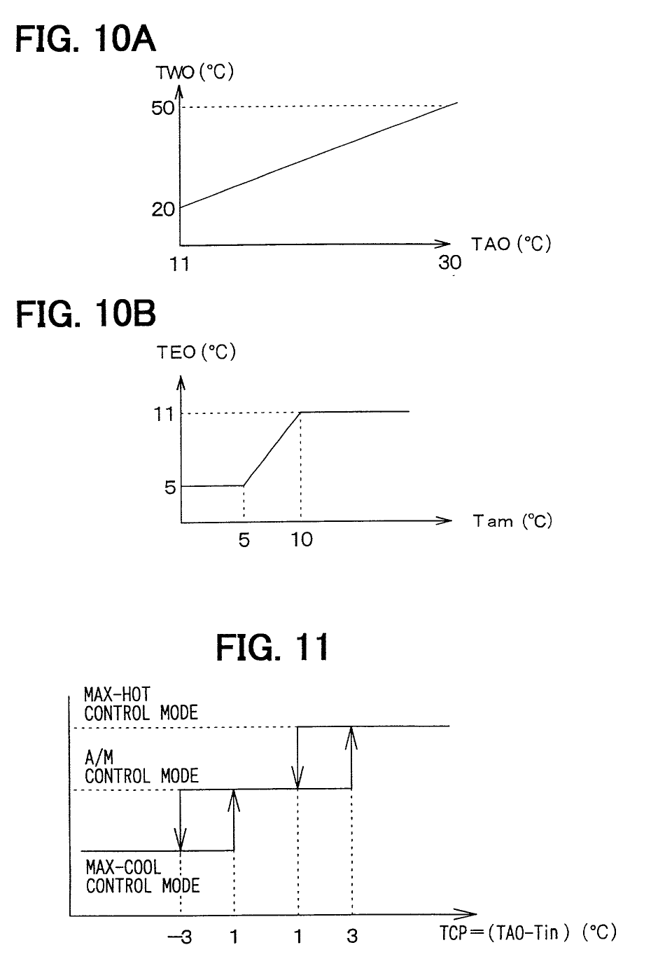

The first embodiment described above may be variously modified. For example, the target coolant temperature TWO under the bilevel mode may be fixed to a certain level which is higher than that determined under the foot mode. Alternatively, the target coolant temperature TWO under the bilevel mode may be set to be linearly raised according to the target temperature TAO, as shown in FIG. 10A. The target temperature after-evaporator TEO may be determined as shown in FIG. 10B.

(Second Embodiment)

A second embodiment of the present invention will be described with reference to FIG. 11. The opening degree SW of the air-mixing door 109 is determined according to the target temperature TAO in the first embodiment. In this second embodiment, SW is determined according to a control parameter temperature TCP which is calculated based on TAO and an intake air temperature Tin. The intake air is the air introduced into the air duct 101 through either the outside air inlet 104 or the inside air inlet 104. The control parameter temperature TCP is calculated in this particular embodiment according to the formula: TCP=TAO−Tin.

The operating mode, i.e., the face mode, the foot mode or the bilevel mode, is determined in the same manner as in the first embodiment. However, the control mode of the air-mixing door 109, i.e., the Max-Hot control mode, the A/M control mode or the Max-Cool control mode, is determined in a manner different from that in the first embodiment. That is, the opening degree SW of the air-mixing door 109 is set to 0% when the control parameter temperature TCP is lower than a third predetermined temperature T3, and SW is set to 100% when TCP is higher than a fourth predetermined temperature T4. When TCP is between T3 and T4, SW is set to the value calculated according to the aforementioned formula: (TAO−TE)/(TW−TE)×100%.

The control modes of the air-mixing door 109 are switched from one mode to another mode with a certain hysteresis in this embodiment, too. FIG. 11 exemplifies the way of switching the control modes. The Max-Cool control mode (SW=0%) is switched to the A/M control mode when TCP (TAO−Tin) reaches 1° C., while the A/M control mode is switched to the Max-Cool control mode when TCP becomes −3° C. Similarly, the A/M control mode is switched to the Max-Hot control mode (SW=100%) when TCP reaches 3° C., while the Max-Hot control mode is switched to the A/M control mode when TCP becomes 1° C.

Since the control parameter temperature TCP becomes positive when heating of the intake air is required, and TCP becomes negative when cooling of the intake air is required, the control of the auxiliary heater 300 and the refrigeration cycle 200 is easily carried out. As understood from the above, the air-conditioner is not necessarily operated under the bilevel mode when the air-mixing door 109 is under the A/M control mode.

The present invention is not limited to the embodiments described above, but it may be variously modified. For example, the auxiliary heater 300 which is electrically powered may be replaced with any other heaters, such as a fuel-combustion-type heater, as long as such heaters are controlled independently from the refrigeration cycle 200. Though the air-conditioner is used in the hybrid vehicle in the foregoing embodiments, it may be used in an electric vehicle solely powered by a battery, such as a fuel cell. Though the heater 107 and the evaporator 201 are placed in the air duct 101 in series along the air stream, they may be placed in respective air ducts which are independent from each other, thereby eliminating the air-mixing door 109. It is also possible to provide an air guide at a downstream position of the heater 107, so that the cool air and the hot air are separated by the air guide under the bilevel mode. If a high amount of heat is available in the coolant, the auxiliary heater 300 may not be necessary, and the amount of heat supplied to the heater 107 may be controlled by adjusting the coolant amount. Both the heating ability and the cooling ability are increased under the bilevel mode, compared with those under other operating modes, in the foregoing embodiments. It is possible, however, to increase either one of the heating ability or the cooling ability under the bilevel mode operation.

While the present invention has been shown and described with reference to the foregoing preferred embodiments, it will be apparent to those skilled in the art that changes in form and detail may be made therein without departing from the scope of the invention as defined in the appended claims.

What is claimed is:

1. An automobile air-conditioner operating under a face mode in which conditioned air is blown upward toward a passenger's face, a foot mode in which conditioned air is blown downward toward passenger's feet, and a bilebel mode in which conditioned air is blown upward toward a passenger's face and downward toward passenger's feet, the automobile air-conditioner comprising:
an air duct through which the conditioned air is blown into a passenger compartment;
an evaporator disposed in the air duct for cooling air introduced into the air duct;
a heater disposed in the air duct for heating air introduced into the air duct;
means for determining a cooling ability of the evaporator and a heating ability of the heater required under the face mode and the foot mode, both the cooling ability and the heating ability being controlled independently from each other; and
means for increasing either one of the cooling ability or the heating ability, or both, which are determined by the determining means, when the air-conditioner operates under the bilevel mode.

2. The automobile air-conditioner as in claim 1, wherein:
the heater is positioned downstream of the evaporator in the air duct;
a bypass passage through which air cooled by the evaporator flows bypassing the heater is formed in the air duct;
an air-mixing door for controlling an amount air flowing through the bypass passage and an amount of air flowing through the heater is disposed in the air duct;
the amount of air flowing through the heater is brought to substantially zero by the air-mixing door when the air-conditioner is operating under the face mode; and
the amount of air flowing through the bypass passage is brought to substantially zero by the air-mixing door when the air-conditioner is operating under the foot mode.

3. The automobile air-conditioner as in claim 2, wherein:
when the air-conditioner is operating under the bilevel mode, the air-mixing door is controlled based on the cooling ability of the evaporator and the heating ability of the heater at that time.

4. The automobile air-conditioner as in claim 1, wherein:
when the air-conditioner is operating under the bilevel mode, either one of the heating ability or the cooling ability, or both, are controlled based on a target temperature of conditioned air blown out of the air duct.

5. An automobile air-conditioner operating under a face mode in which conditioned air is blown upward toward a passenger's face, a foot mode in which conditioned air is blown downward toward passenger's feet, and a bilebel mode in which conditioned air is blown upward toward a passenger's face and downward toward passenger's feet, the automobile air-conditioner comprising:
an air duct through which the conditioned air is blown into a passenger compartment;
an evaporator disposed in the air duct for cooling air introduced into the air duct;
a heater disposed in the air duct for heating air introduced into the air duct;
means for determining a cooling ability of the evaporator and a heating ability of the heater required under the face mode and the foot mode, both the cooling ability and the heating ability being controlled independently from each other;
means for determining a target temperature of conditioned air blown out of the air duct;
means for determining a control parameter temperature based on the target temperature of conditioned air blown out of the air duct and a temperature of intake air introduced into the air duct; and
means for selecting an operating mode from among the face mode, the foot mode and the bilevel mode based on the target temperature of conditioned air blown out of the air duct, wherein:
the selecting means selects the face mode when the target temperature is equal to or lower than a first predetermined temperature, the bilevel mode when the target temperature is higher than the first predetermined temperature and equal to or lower than a second predetermined temperature, and the foot mode when the target temperature is higher than the second predetermined temperature; and
either one of the cooling ability or the heating ability, or both, determined by the cooling ability and heating ability determining means, are increased when the control parameter temperature determined by the control parameter temperature determining means is higher than a third predetermined temperature and equal to or lower than a fourth predetermined temperature.

6. The automobile air-conditioner as in claim 5, wherein:
the heater is positioned downstream of the evaporator in the air duct;
a bypass passage through which air cooled by the evaporator flows bypassing the heater is formed in the air duct;
an air-mixing door for controlling an amount air flowing through the bypass passage and an amount of air flowing through the heater is disposed in the air duct;
the amount of air flowing through the heater is brought to substantially zero by the air-mixing door when the control parameter temperature is equal to or lower than the third predetermined temperature; and
the amount of air flowing through the bypass passage is brought to substantially zero by the air-mixing door when the control parameter temperature is higher than the fourth predetermined temperature.

7. The automobile air-conditioner as in claim 6, wherein:
when the control parameter temperature is higher than the third predetermined temperature and equal to or lower than the fourth predetermined temperature, the air-mixing door is controlled based on the cooling ability of the evaporator and the heating ability of the heater at that time.

8. The automobile air-conditioner as in claim 5, wherein:
when the control parameter temperature is higher than the third predetermined temperature and equal to or lower than the fourth predetermined temperature, either one of the heating ability or the cooling ability, or both, are controlled based on the control parameter temperature.

9. The automobile air-conditioner as in claim 1, wherein:
the evaporator is a low pressure side heat exchanger in a vapor-compressing refrigeration cycle;
the compressor is driven by an electric motor; and
the heater includes an auxiliary electric heater.

10. The automobile air-conditioner as in claim 5, wherein:
the evaporator is a low pressure side heat exchanger in a vapor-compressing refrigeration cycle;
the compressor is driven by an electric motor; and
the heater includes an auxiliary electric heater.
